(19) United States
(12) Patent Application Publication
(10) Pub. No.: US 2012/0288594 A1
(43) Pub. Date: Nov. 15, 2012

(54) METHOD AND PLANT FOR PACKAGING FRESH FOOD PRODUCTS, SUCH AS FRUIT AND VEGETABLES, AND FOOD PRODUCT THUS PACKAGED

(75) Inventors: Angelo Della Valentina, Polcenigo (PN) (IT); Rudi Toneatti, Sequals (PN) (IT)

(73) Assignee: DIVTI QUARTAGAMMA SRL, Sequals (PN) (IT)

(21) Appl. No.: 13/103,686

(22) Filed: May 9, 2011

(51) Int. Cl. A23B 7/16; B65B 5/06

(52) U.S. Cl. 426/125; 426/414; 53/111 R

(57) ABSTRACT

A method for packaging a fresh food product, such as fruit and vegetables, provided externally with a protective peel, having at least a peeling step, in which the peel is removed from the product. After the peeling step, the method provides at least a covering step, in which at least a covering film is associated with the external surface of the product. The method also provides a molding step in which the covering film is made to adhere to the external surface of the product.

### FIELD OF THE INVENTION

The present invention concerns a method and the relative plant for packaging fresh food products, such as fruit and vegetables. In particular, the present invention is used for packaging fresh fruit and vegetables, for example apples, pears, oranges, carrots, bananas and others, intended for individual distribution in automatic distributors in public places.

### BACKGROUND OF THE INVENTION

Fresh food products are known, such as fruit and vegetables, commonly sold retail and in large scale retail outlets, loose or disposed on containers or boxes made of plastic, wood or cardboard.

The products are generally sold complete with the peel which is removed, if necessary, by the consumer when they are eaten.

The products are necessarily sold with the peel due to the fact that the desired freshness of the product on the counter must be guaranteed at least for some days.

In fact, if they are preserved with the peel in a cool dry place, the products keep their organoleptic properties substantially unchanged for some days whereas, if they have no peel, they deteriorate in the space of a few hours, due to the effect of the oxidation of the hydroquinones inside them.

The habit of having quick snacks with fresh, natural products is becoming more and more common, even outside the house, as an alternative to the high-caloric food that is typical of long-preservation snacks with additives, produced industrially.

However, fresh products, like fruit and vegetables, for example apples, pears, carrots, and others, are difficult to distribute individually in traditional automatic snack distributors.

This is due to the fact that, since it is necessary to guarantee a practical and speedy consumption for the user, also considering that natural products must be preserved with their peel, if they were to be distributed in automatic distributors, this would entail a simultaneous distribution of utensils in order to remove the peel at the moment of consumption

Furthermore, if the product is peeled, there are problems relating to the juice which, to a lesser or greater extent, can come out of the product and dirty the user's hands or stain his/her clothes.

The need to distribute fresh products such as fruit and vegetables individually is even more prevalent in school institutions, since it is preferable that children's diet should include fruit and vegetables for a correct intake of fibers and vitamins, and that the consumption of industrially produced quick snacks should be reduced. Children, however, are unable to use cutting utensils efficiently and with due attention in order to remove the peel from fruit and vegetables and are therefore obliged to eat such products with the peel. Very often, even if washed, the peel has chemical products used in agriculture, wax or microorganisms.

Document U.S. Pat. No. 4,034,536 discloses an automatic packaging apparatus and methods for packaging sliced food products substantially flat such as bacon in evacuated or gas-filled packages.

Document U.S. Pat. No. 4,835,942 discloses a seafood vacuum-pack system for producing a vacuum packed shrimp pack.

Purpose of the present invention is to perfect a method, and the relative plant, to distribute individually fresh food products by means of automatic distributors, guaranteeing both that the organoleptic properties of the natural fresh product are maintained without using preservatives and/or additives of various types, and also that the products can be consumed in a practical and rapid manner, substantially for every type of user.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purpose, a method for packaging fresh food products, such as fruit and vegetables provided on the outside with a protective peel, comprises at least a peeling step, in which the peel is removed from said product.

According to a characteristic feature of the present invention, after the peeling step, the peel is replaced in its functions of protecting and preserving the product with at least a covering film made of thermo-formable and flexible material by means of at least a covering step, in which said at least a film of material, advantageously but not necessarily totally or partly transparent, is associated with the external surface of the food product. Said covering step comprises a first shaping sub-step, in which a first film in the form of a strip made of thermo-formable and flexible material is shaped so as to define a seating having a shape correlated to the product, a second positioning sub-step in which said product is deposited in said seating, and a third covering sub-step in which a second film in the form of a strip made of thermo-formable and flexible material is positioned above the first film so as to cover the whole surface of the product. Moreover, the method of the present invention comprises a molding step in which the film is made to adhere to the external surface of the food product by depositing said second film so as to assume, also thanks to the flexibility property thereof, a shape correlated to the product so that the bulk of the package is substantially equal to that of the non-packaged product.

With this method we obtain a natural product in which the film replaces the peel in its functions of protecting and preserving the product but, unlike the peel, it is easily removed without the aid of utensils. The package thus obtained envelops, or surrounds completely, the fresh food product. Moreover, the bulk of the package is substantially equal to that of the non-packaged product, and therefore suitable for the limited spaces of the compartments of automatic distributors.

In this way it is also possible to package products substantially spherical in shape, without the film forming bends and overlapping on the surface of the product.

According to a variant, in the case of thermo-formable film, after the molding step, a step of heat-retraction is provided, in which the film is made to shrink so as to adhere further to the surface of the product.

This solution allows to increase further the adherence of the film to the product, with a final result that simulates the peel.

According to a variant, before the covering step, the present invention comprises a step of anti-oxidizing treatment, in which the peeled product is treated with an anti-oxidant solution in order to delay browning and to increase duration.

According to a variant, the molding step provides a sub-step to create a vacuum, in which the air between the film and the product is taken in.

This operation, eliminating or reducing the presence of oxygen in contact with the product, reinforces the effect of the anti-oxidizing treatment and allows to further extend the duration of the product.

According to another variant, after the vacuum step, the molding step comprises a sealing step in which the film is made solid in a closing zone, and a trimming sub-step in which the film is trimmed along the line of solidarization.

Solidarization makes the package hermetic, thus preventing any contamination of the product by external agents and also prevents any air from entering.

According to a variant, before the step of anti-oxidizing treatment, the method comprises a cutting step, in which the product is cut into portions of a predefined shape, for example segments or round pieces, which are kept together to form the original shape of the product.

This solution is particularly advantageous in the case of products intended for distribution in public places, such as for example hospitals, rest homes and schools, frequented by consumers who need to be able to eat the product in pieces that are easily picked up by hand, and not bitten.

According to another variant, the film is a color that reproduces the appearance of the packaged food product. In this way, the product is more easily recognizable by the consumer and is aesthetically more pleasing.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a schematic view of a packaging plant according to the present invention;

FIG. 2 is a lateral schematic view of a detail of the plant in FIG. 1;

FIG. 3a is a lateral view of a product during the packaging step with the plant in FIG. 1;

FIG. 3b is a three-dimensional view of a part of FIG. 3a;

FIG. 4 is a perspective view of the packaged product made with the plant in FIG. 1;

FIG. 5 is a block diagram of a packaging method according to the present invention.

### DETAILED DESCRIPTION OF A PREFERENTIAL FORM OF EMBODIMENT

With reference to the attached drawings, a plant 10 according to the present invention is used to package fresh food products, in this case apples 20, but the following description is not to be intended as limited to apples, applying also to other fresh food products that can be packaged with the present invention.

The following example provides to use film made of thermo-formable and flexible material.

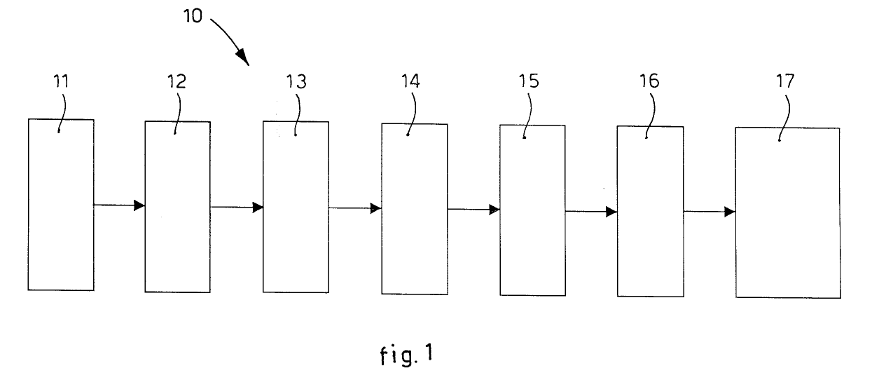

With particular reference to FIG. 1, the plant 10 comprises a loading station 11, a washing tank 12, a peeling station 13, a grading station 14, an anti-oxidizing treatment tank 15, a drying station 16 and a packaging station 17.

The loading station 11, washing tank 12, peeling station 13, grading station 14, anti-oxidizing treatment tank 15 and drying station 16 are substantially of a known type.

In particular, the apples 20, or other fresh food products, are loaded into the loading station 11 and made to slide into the washing tank 12 in which they are washed, generally with water.

The washing tank 12 comprises lifting means that pick up the apples 20 and convey them toward the peeling station 13.

The peeling station 13 comprises an orientation device that rotates the apples 20 until the stalk-sepal axis is in a vertical direction, and peeling means that peel the apples 20, for example by turning, and possible remove the core.

In the grading station 15, for example comprising a conveyor belt, the apples 20 that are unsuitable are identified and discarded, either manually or automatically.

The suitable apples 20 are immersed for a determinate period of time in the anti-oxidizing treatment tank 15, containing an anti-oxidant solution, for example a solution of ascorbic acid, and are subsequently dried in the drying station 16 for example by means of ventilators.

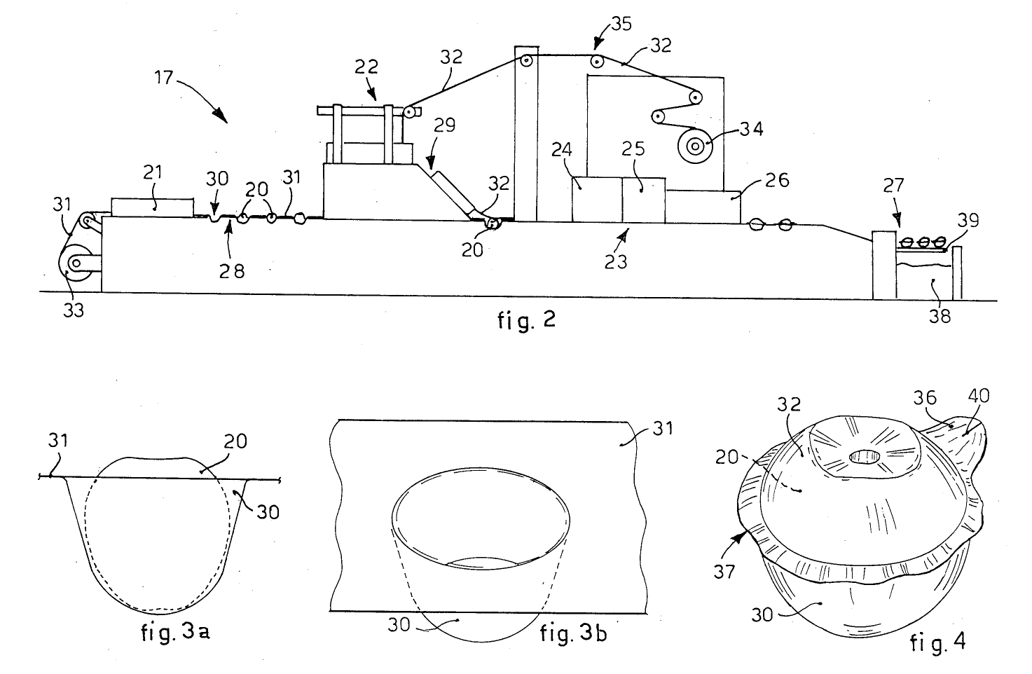

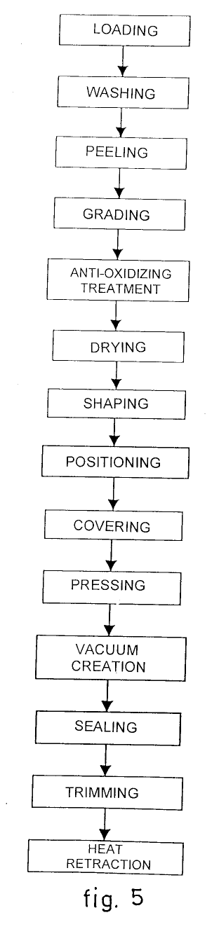

With particular reference to FIG. 2, the packaging station 17 comprises shaping means 21, feed means 28, covering means 22, a sealing unit 23 and heat-retraction means 27.

The packaging station 17 also comprises a first unwinding roller 33, disposed upstream of the shaping means 21, and able to feed to the shaping means 21 a first film 31 of thermo-formable and flexible material, in the form of a strip, and a second unwinding roller 34, associated with the covering means 22 and able to feed to the covering means 22 a second film 32 of thermo-formable and flexible plastic material, in the form of a strip.

The shaping means 21 comprise a mold with a shape correlated with the shape of part of the apple 20, or other fresh food products, to be packaged, able to pre-form the first film 31.

In this case the mold is shaped to pre-form the first film 31 so that it covers more than half of the apple 20, or other fresh food products, excluding an upper cap.

By molding, a seating 30 is formed on the strip (FIGS. 3a and 3b) into which the apple is placed manually when it exits from the shaping means 21.

The feed means 28 are provided immediately downstream of the shaping means 21.

In this case, the feed means 28 comprise two chains disposed parallel at a distance equal to the width of the first film 31, each of which is disposed annularly on two pulleys. The pulleys, which cannot be seen in the drawings, are disposed respectively one immediately upstream of the shaping means 21, and one immediately downstream of the sealing unit 23.

An edge of the first film 31 is associated with each chain, to feed it toward the sealing unit 23.

In this way the first film 31 also functions as a conveyor belt for the apples 20.

According to a variant, downstream of the shaping means 21, in the direction of feed of the first film 31, positioning means are provided, able to position the apple 20 in the seating 30 in an automated manner.

Downstream of the shaping means 21 and upstream of the sealing unit 23 the covering means 22 are disposed, comprising a plurality of tensioning rollers 35 and a positioning device 29, which gradually position the second film 32 above the apples 20 during the advance of the first film 31 and the apples 20 from the shaping means 21 to the sealing unit 23.

The second film 32 advances solid with the first film 31 toward the sealing unit 23.

The sealing unit 23 comprises a vacuum formation device 24 which takes in the air present between the two films 31 and 32 and the surface of the apple 20. Thanks to the flexibility properties of the first 31 and second film 32, the vacuum condition that is applied is also able to give the desired shape to the final packaging that completely covers the apple 20, closely adhering to the surface thereof.

The sealing unit 23 also comprises sealing means 25 that weld the two films 31 and 32 to each other in the perimeter zone of the apple 20. The films are welded using known methods, for example melting, pressure, laser or other.

The sealing unit 23 comprises trimming means 26, disposed downstream of the sealing means 25, which cut the two films 31 and 32 along the edge of the sealed portion 37 (FIG. 4).

Advantageously, the trimming means 26 shape a tongue 36, comprising a portion of the same shape and size as each of the two films 31 and 32. A longitudinal cut 40 is made on the tongue 36, for an easy opening of the package.

The sealing unit 23 feeds the heat-retraction means 27.

The heat-retraction means 27 comprise a heat-retraction tank 38 containing hot water, at a temperature such as to cause the films 31 and 32 to shrink so as to further closely adhere to the apple 20, thus completely surrounding the same in a reliable manner, and a holed platform 39, disposed movable vertically inside the heat-retraction tank 38.

The covered apples 20 are loaded, manually or by means of automatic devices, onto the platform 39 when the latter is at a level above the surface of the water of the heat-retraction tank 38. Subsequently, the platform 39 moves downward to a level where the apples 20 are completely immersed in the water. The platform 39 remains in this position for the time needed for the films 31 and 32 to shrink, and then returns to the initial level, above the surface of the water.

The holes of the platform 39 are able to drain the apples 20 of residual water after immersion.

According to a variant, the packaging station 17 provides a device, associated with the shaping means 23, to recover the off cuts from the trimming of the films 31 and 32.

The device to recover the off cuts is for example of the suction type, and comprises a plurality of suction tubes disposed in correspondence with the trimming means 26.

It is clear, however, that modifications and/or additions of parts may be made to the plant 10 as described heretofore, without departing from the field and scope of the present invention.

It is also clear that, although the present invention has been described with reference to some specific examples, a person of skill in the art shall certainly be able to achieve many other equivalent forms of plant for packaging fresh food product, having the characteristics as set forth in the claims and hence all coming within the field of protection defined thereby.

1. A method for packaging a fresh food product provided externally with a protective peel, comprising:
at least a peeling step, in which the peel is removed from said product,
at least a covering step after the peeling step,
wherein the covering step replaces the peel in its functions of protecting and preserving the product with at least a covering film made of thermo-formable and flexible material in which said at least a covering film is associated with the external surface of said product,
said covering step comprising:
a first shaping sub-step, in which a first film in the form of a strip made of thermo-formable and flexible material is shaped to define a seating having a shape correlated to the product,
a second positioning sub-step in which said product is deposited in said seating, and
a third covering sub-step in which a second film in the form of a strip made of thermo-formable and flexible material is positioned above the first film to cover the whole surface of the product, and
a molding step in which said covering film is made to adhere to the external surface of said product by depositing said second film to assume a shape correlated to the product so the bulk of the package is substantially equal to the bulk of the non-packaged product.

2. The method as in claim 1, wherein the molding step comprises a sealing sub-step in which the covering film is made solid in correspondence with a predefined closing zone, and a trimming sub-step in which said covering film is trimmed along the edge of the portion made solid.

3. The method as in claim 1, wherein the molding step comprises a sub-step of creating a vacuum, in which air present between said covering film and said product is taken in.

4. The method as in claim 1, wherein said molding step comprises a sealing sub-step in which said first film and said second film are made solid with each other along a predefined peripheral portion, and a trimming sub-step in which said first film and said second film are trimmed along the edge of the portion made solid.

5. The method as in claim 1, wherein, before the covering step, the method comprises an anti-oxidizing treatment of said product.

6. The method as in claim 5, wherein, before the anti-oxidizing treatment, the method comprises a cutting step in which said product is pre-cut into portions of a predefined shape kept associated to form the original shape of the product.

7. The method as in claim 1, wherein, after the molding step, a step of heat retraction is provided, in which said covering film is made to shrink by means of hot water, at a temperature to cause the first and second film to shrink to adhere further to the surface of the product.

8. The method as in claim 1, wherein the product is made to advance by means of the first film that also functions as a conveyor belt.

9. The method as in claim 1, wherein the fresh food product is an apple and the covering step is configured to package products substantially spherical in shape by pre-forming the first film so said first film covers more than half of the apple, excluding an upper cap and gradually positioning the second film above the apple during the advance of the first film and the apple from the shaping means, without the covering film forming bends and overlapping on the surface of the product.

10. A plant for packaging a fresh food product provided externally with a protective peel, comprising at least a peeling station for removing the peel from said product, the plant comprising
a packaging station suitable for replacing the peel in its functions of protecting and preserving the product with at least a covering film made of thermo-formable and flexible material, said packaging station being provided at least with:
a covering unit for positioning at least a covering film on the external surface of said product and comprising
shaping means for shaping a first film to define a seating having a shape correlated to the shape of the product, and in which said product is deposited, and
covering means, cooperating with said shaping means for positioning a second film above the first film to cover the whole surface of the product,
a sealing unit making said covering film adhere to the surface of said product by depositing said second film to assume a shape correlated to the product so the bulk of the package is substantially equal to the bulk of the non-packaged product.

11. The plant as in claim 10, wherein said sealing unit comprises a device to create a vacuum, disposed downstream of said covering unit and able to take in air present between said covering film and said product.

12. The plant as in claim 10, wherein said sealing unit comprises sealing means for making solid said covering film in correspondence with a predefined closing zone, and trimming means, disposed downstream of said sealing means and for trimming said covering film along the edge of the portion made solid.

13. The plant as in claim 10, wherein said packaging station comprises heat retraction means, disposed downstream of said sealing unit for shrinking said covering film by using hot water, at a temperature to cause the first and second film to shrink to adhere further to the surface of the product.

14. The plant as in claim 10, comprising a conveyor belt for advancing the product made by the first film.

15. The plant as in claim 10, wherein the fresh food product is an apple and the covering unit is configured to package products substantially spherical in shape, wherein the shaping means are shaped to pre-form the first film so said first film covers more than half of the apple, excluding an upper cap and the covering means are configured for gradually positioning the second film above the apple during the advance of the first film and the apple from the shaping means, without the covering film forming bends and overlapping on the surface of the product.

16. A packaged fresh food product without the protective peel, wherein the peel is replaced in its functions of protecting and preserving the product with at least a covering film made of thermo-formable and flexible material adhered to the external surface of said product,
said covering film comprising a first film, shaped to define a seating having a shape correlated to the product in which the product is disposed, and a second film, positioned above the first film to cover the whole surface of the product, and deposited to assume a shape correlated to the product and the bulk of the package formed by the covering film is substantially equal to the bulk of the non-packaged product.

17. The packaged fresh food product as in claim 16, wherein the first film and the second film are heat-retracted by using hot water, at a temperature to cause the first and second film to shrink, to adhere further to the surface of the product.

18. The packaged fresh food product as in claim 16, wherein the fresh food product is an apple and the first film covers more than half of the apple, excluding an upper cap and the second film is positioned above the apple, without the covering film forming bends and overlapping on the surface of the product.

19. The method as in claim 1, wherein the fresh food product comprises at least one member of the group consisting of a fruit and a vegetable.

20. The plant as in claim 10, wherein the fresh food product comprises at least one member of the group consisting of a fruit and a vegetable.

21. The packaged fresh food product as in claim 16, wherein the fresh food product comprises at least one member of the group consisting of a fruit and a vegetable.
